(19) United States
(12) Patent Application Publication
(10) Pub. No.: US 2006/0244679 A1
(43) Pub. Date: Nov. 2, 2006

(54) Plasma display panel

(75) Inventors: Hyun Kim, Chunan-si (KR); Heung-Sik Tae, Chunan-si (KR)

Correspondence Address: H.C. PARK & ASSOCIATES, PLC, 8500 LEESBURG PIKE, SUITE 7500, VIENNA, VA, 22182, US

(73) Assignee: SAMSUNG SDI CO., LTD.

(21) Appl. No.: 11/390,289

(22) Filed: Mar. 28, 2006

(30) Foreign Application Priority Data
Apr. 29, 2005 (KR) 10-2005-0035976

(51) Int. Cl. G09G 3/10

(52) U.S. Cl. 345/37

(57) ABSTRACT

A Plasma Display Panel (PDP) is driven with a long discharge gap between display electrodes to generate a positive column. The PDP includes first and second substrates disposed opposite to each other, barrier ribs partitioning discharge cells, address electrodes positioned on the first substrate, and display electrodes extending in a second direction and crossing with the address electrodes in regions corresponding to the discharge cells. A long distance gap between display electrodes in a discharge cell is greater than a distance between a display electrode and the address electrode, and discharge is initiated between the address electrode and the first display electrode. Discharge diffuses along the address electrode until main discharge is generated in the long discharge gap between display electrodes to increase panel efficiency. Furthermore, the address electrodes are curved and have a path longer than a discharge cell length to increase a high intensity brightness region.

### CROSS REFERENCE TO RELATED APPLICATION

This application claims priority to and the benefit of Korean Patent Application No. 10-2005-0035976, filed on Apr. 29, 2005, which is hereby incorporated by reference for all purposes as if fully set forth herein.

### BACKGROUND OF THE INVENTION

1. Field of the Invention

The present invention relates to a plasma display panel (PDP). More particularly, the present invention relates to a PDP with a long discharge gap between display electrodes, thus generating a positive column.

2. Discussion of the Background

A PDP is a display device that generates images by exciting phosphors with vacuum ultraviolet (VUV) rays, which are first generated by a gas discharge within a discharge cell. A PDP can be classified as a DC type or an AC type depending on the driving voltage waveform applied and the structure of the PDP's discharge cell. An AC type PDP with a three-electrode surface-discharge structure has extensively developed for consumer use.

In a common AC type PDP, a front substrate and a rear substrate are disposed separate and opposite to each other with barrier ribs are formed therebetween. In addition, a plurality of discharge cells are partitioned by the barrier ribs. Further, address electrodes are formed on the rear substrate to correspond to discharge cells, and display electrodes are formed on the front substrate. The display electrodes can include a scan electrode and a sustain electrode, depending on the PDP function and mode of operation. The address electrodes and the display electrodes can each be covered with a dielectric layer. A phosphor layer can be located in each discharge cell. The discharge cells can be filled with a discharge gas, which may include a Ne—Xe gas mixture. A distance between a scan electrode and a sustain electrode in a discharge cell is defined as the discharge gap, and a short discharge gap of approximately 60 μm to 120 μm is common within a discharge cell.

In general, the AC PDP is driven with one frame of the desired image being divided into a plurality of subfields. The three subfields can include a reset period, an address period, and a sustain period.

In the reset period, every discharge cell is initialized and wall charges from a previous discharge are reset so that an address operation can be smoothly performed on the discharge cell. In the address period, a discharge cell to be turned on is selected and wall charges are accumulated on the selected discharge cell. In the sustain period, a discharge is generated in the selected discharge cell for emitting light of a predetermined color and intensity and displaying images on the PDP.

For an AC type PDP, extensive research into improving panel efficiency, defined as the ratio of power consumption to brightness, has been performed. In the conventional discharge cell structure having the aforementioned short discharge gap however, panel efficiency is approaching its limit. Therefore, there has been active research into a new discharge cell structure and a new driving method. This research includes a technique employing a positive column discharge characteristic.

According to the above technique, a long discharge gap of approximately 400 μm or greater, can be formed between a scan electrode and a sustain electrode within one discharge cell. In addition, with this technique, a positive column generated in the long discharge gap can be used for driving a PDP, thus improving panel efficiency. In an AC type PDP employing this positive column discharge characteristic, however, a great distance between display electrodes may result in an undesirable increase in discharge firing voltage and sustain voltage.

The above information disclosed in this Background section is only for enhancement of understanding of the background of the invention.

### SUMMARY OF THE INVENTION

This invention provides a PDP with improved panel efficiency where a positive column is generated with a low voltage from a long discharge gap formed between display electrodes, and with improved brightness and luminous efficiency by controlling the shape of address electrodes to expand the distribution of visible ray radiation.

Additional features of the invention will be set forth in the description which follows, and in part will be apparent from the description, or may be learned by practice of the invention.

The present invention discloses a plasma display panel including a first substrate and a second substrate disposed opposite to each other, a barrier rib disposed between the first substrate and the second substrate and partitioning a plurality of discharge cells, an address electrode disposed on the first substrate and extending in a first direction, and a first display electrode and a second display electrode disposed on the second substrate and extending substantially parallel to each other in a second direction substantially perpendicular to the first direction, the first display electrode and the second display electrode crossing with the address electrode at a region corresponding to a discharge cell. Further, a distance between the first display electrode and the second display electrode is greater than a distance between the first display electrode and the address electrode, and a portion of the address electrode corresponding to the discharge cell has a path longer than a length of the discharge cell measured in the first direction.

The present invention also discloses a plasma display panel including a first substrate and a second substrate disposed opposite to each other, a barrier rib disposed between the first substrate and the second substrate and partitioning a plurality of discharge cells, an address electrode disposed on the first substrate and extending in a first direction, a portion of the address electrode corresponding to the discharge cell has a path longer than a length of the discharge cell measured in the first direction, and a first display electrode and a second display electrode disposed on the second substrate and extending substantially parallel to each other in a second direction substantially perpendicular to the first direction. Further, the first display electrode and the second display electrode correspond to a discharge cell and are formed of an opaque material.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a partial exploded perspective view of a PDP according to a first exemplary embodiment and a second exemplary embodiment of the present invention.

FIG. 2 is a partial sectional view of a PDP taken along line II-II of FIG. 1 according to a first exemplary embodiment of the present invention.

FIG. 3 is a partial top view of a PDP according to a first exemplary embodiment of the present invention.

FIG. 4 is a partial sectional view of a PDP according to a second exemplary embodiment of the present invention.

FIG. 5 is a partial top view of a PDP according to a second exemplary embodiment of the present invention.

FIG. 6A is a sustain waveform diagram for a PDP according to an exemplary embodiment of the present invention.

FIG. 6B is a schematic diagram for illustrating the formation of a discharge within a discharge cell in a PDP according to an exemplary embodiment of the present invention.

FIG. 7 is a schematic diagram for illustrating the distribution of visible ray radiation within a discharge cell, which is monitored when a PDP according to an exemplary embodiment of the present invention is driven.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element such as a layer, film, region or substrate is referred to as being “on” another element, it can be directly on the other element or intervening elements may also be present. In contrast, when an element is referred to as being “directly on” another element, there are no intervening elements present.

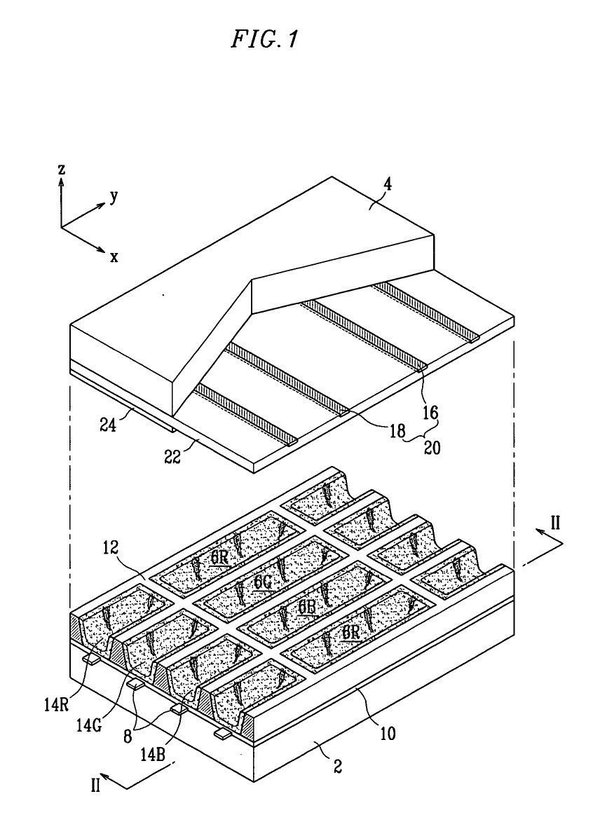

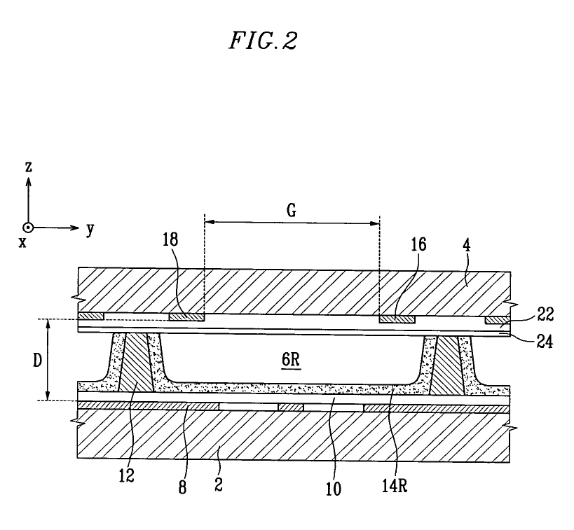

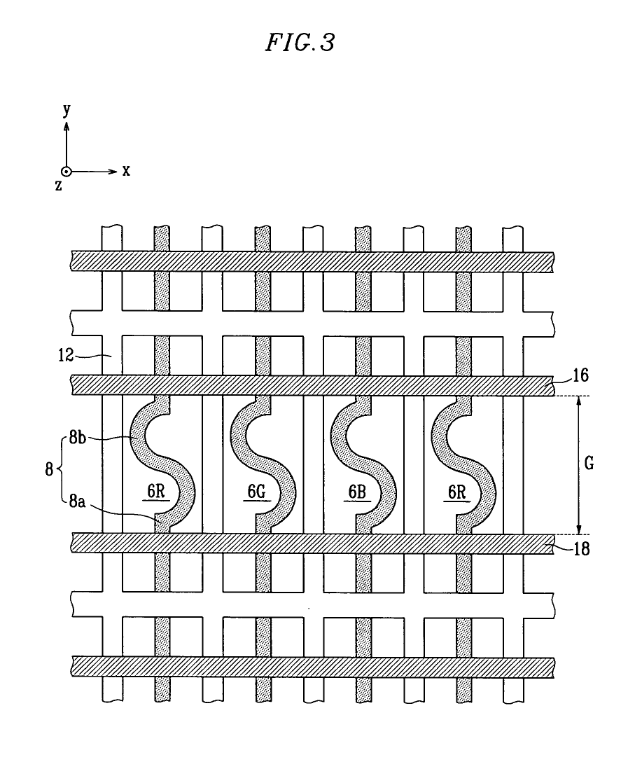

FIG. 1 is a partial exploded perspective view of a PDP according to a first exemplary embodiment and a second exemplary embodiment of the present invention. FIG. 2 is a partial sectional view of a PDP taken along line II-II of FIG. 1 according to a first exemplary embodiment of the present invention. FIG. 3 is a partial top view of a PDP according to a first exemplary embodiment of the present invention.

Referring to FIG. 1, FIG. 2, and FIG. 3, a PDP includes a rear substrate 2 and a front substrate 4, which are disposed separate and opposite to each other. A number of discharge cells 6R, 6G, and 6B are provided in spaces between the substrates 2 and 4 and partitioned by lattice-type barrier ribs 12. Visible rays are radiated from the discharge cells 6R, 6G, and 6B by an independent discharge mechanism, thus generating predetermined color images.

Address electrodes 8 are formed on the rear substrate 2 and extending in a first direction, shown as the y-axis direction. A first dielectric layer 10 is formed on the rear substrate 2 and covers the address electrodes 8. The address electrodes 8 are positioned in a predetermined pattern with a predetermined distance between successive address electrodes 8. The lattice-type barrier ribs 12 extend in the first direction, shown as the y-axis direction, and a second direction, shown as the x-axis direction, which crosses the first direction. The lattice-type barrier ribs 12 are formed on the first dielectric layer 10. The shape of the barrier ribs 12 is not restricted to the lattice type, but can be other closed types of shapes other than a stripe type or a lattice type. Red phosphor layers 14R, green phosphor layers 14G, and blue phosphor layers 14B are formed on the four sides of the barrier ribs 12 and on the first dielectric layer 10.

Furthermore, display electrodes 20, including a scan electrode 16 and a sustain electrode 18 in each discharge cell, are formed on an inner surface of the front substrate 4 opposite to the rear substrate 2. The display electrodes 20 extend in a second direction, shown as the x-axis direction, and cross with the address electrodes 8. A transparent second dielectric layer 22 and an MgO protective layer 24 are disposed on the inner surface of the front substrate 4, and cover the display electrodes 20.

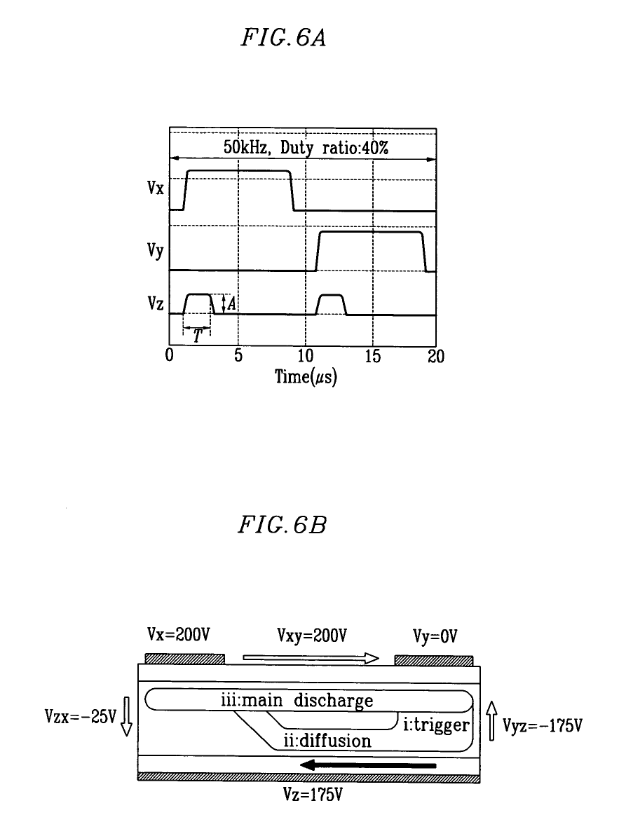

In the present exemplary embodiment, a discharge gap between the scan electrode 16 and the sustain electrode 18 can be a long discharge gap set to approximately 400 μm or greater. The discharge gap G between the scan electrode 16 and the sustain electrode 18, as shown on FIG. 2 and FIG. 3, is greater than a distance D between the address electrode 8 and the display electrode 20 as shown on FIG. 2. As shown in FIG. 3, the scan electrode 16 and the sustain electrode 18 are disposed corresponding to each other across the discharge cells 6R, 6G, and 6B and have a long discharge gap therebetween. It is known that such a long discharge gap may increase panel efficiency through generation of a positive column. However, such an electrode structure may require an excessive discharge firing voltage and sustain voltage. Thus, the present exemplary embodiment discloses a new driving method for lowering a discharge firing voltage and a sustain voltage with a long discharge gap. This driving method will be described in further detail with reference to FIG. 6A and FIG. 6B below.

Furthermore, as shown in FIG. 3, to increase the length of the positive column, the address electrode 8 is formed with a straight-line part 8a extending in the first direction, the y-axis direction, and a curved part 8b, at least some of which is curved. In the present exemplary embodiment, the curved part 8b has an S shape that is curved at least twice along the length, the y-axis direction, of the address electrode 8. Therefore, a path along two edges of the electrode extending in the x-axis direction of each of the discharge cells and a path along two edges of the electrode extending in the y-axis direction of each of the discharge cells are longer. Thus, the length of a main discharge that generates the positive column is increased and a greater intensity of visible rays is obtained, improving brightness.

Furthermore, the curved part 8b of the address electrode 8 forms a path in the +x direction along one edge of the discharge cells 6R, 6G, and 6B, and forms a path in the opposite −x direction along the other edge of the discharge cells 6R, 6G, and 6B. In addition, when the curved part 8b is provided, the length of a path along an edge of the address electrode positioned proximate and adjacent to the lateral wall of each of the discharge cells 6R, 6G, and 6B can be is made longer. As described above, since the curved part 8b is provided in the address electrode 8 according to the present exemplary embodiment, the use of discharge spaces can be maximized. Moreover, the curved parts 8b are symmetrical about the center of the discharge cells 6R, 6G, and 6B. The discharge spaces can be employed uniformly.

The address electrode 8, the scan electrode 16, and the sustain electrode 18 manufactured as described above need not be a transparent electrode with high resistance. Rather, the address electrode 8, the scan electrode 16, and the sustain electrode 18 can be opaque with low resistance. For example, the address electrode 8, the scan electrode 16, and the sustain electrode 18 can be a metal electrode with good conductivity such as Ag.

When an address voltage is applied between the address electrode 8 and the scan electrode 16 of a discharge cell, such as a red discharge cell 6R, an address discharge is generated in the discharge cell 6R. As a result of the address discharge, wall charges accumulate on the second dielectric layer 22 covering the display electrode 20, and the discharge cell 6R is hereby selected or turned on.

Thereafter, if a sustain voltage is applied between the scan electrode 16 and the sustain electrode 18 of the selected discharge cell 6R and an assistant voltage is applied to the address electrode, a negative electric field is formed between the scan electrode 16 and the address electrode 8 or between the sustain electrode 18 and the address electrode 8. After a discharge begins between the scan electrode 16 and the address electrode 8 or between the sustain electrode 18 and the address electrode 18, the discharge spreads along the length of the address electrode 8. As the discharge approaches both ends of the address electrode 8, a main discharge by the positive column is finally generated between the scan electrode 16 and the sustain electrode 18 with a long gap therebetween. VUV rays are thus generated from excited Xe atoms, which are produced upon discharge of the gas in the discharge cell 6R. The VUV rays excite the phosphor layer 14R in the discharge cell 6R, thus generating visible rays, and red light is thus emitted from the phosphor layer 14R and from the discharge cell 6R to form an image on the PDP.

As described above, in the PDP according to the first exemplary embodiment, the length of a portion of a discharge cell with high brightness along the address electrode 8 is lengthened by the addition of the curved part 8b to the address electrode 8. Accordingly, brightness is improved. Furthermore, by lengthening a discharge gap between the scan electrode 16 and the sustain electrode 18, the brightness of a screen can be enhanced and luminous efficiency can also be improved.

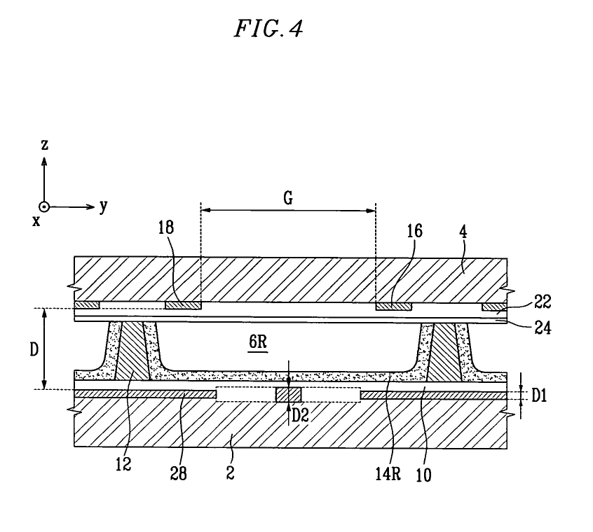

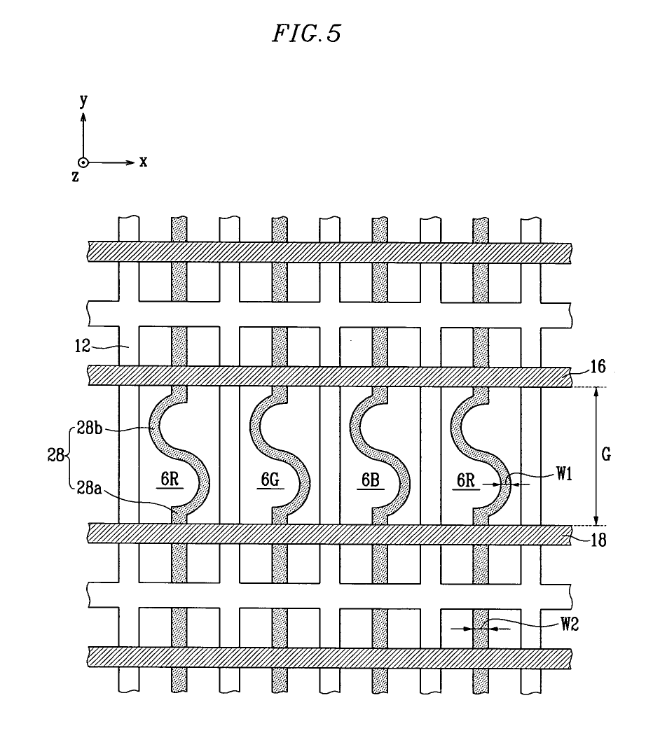

A second exemplary embodiment of the present invention will be described below with reference to FIG. 4 and FIG. 5.

FIG. 4 is a partial sectional view of a PDP according to a second exemplary embodiment of the present invention. FIG. 5 is a partial top view of a PDP according to a second exemplary embodiment of the present invention.

As shown in FIG. 4 and FIG. 5, the second exemplary embodiment has the structure of the first exemplary embodiment, wherein the width of the address electrode 28 is thinner than the width of the address electrode 8 in the first exemplary embodiment. In the second exemplary embodiment, the address electrodes 28 have an S shape within discharge cells. Further, to reduce an address current that may increase as the path of the address electrode 28 increases, the width of at least part of the address electrode 28 is narrower than the width of the address electrode 8 in the first exemplary embodiment. The width W1 of an address electrode 28 curved part 28b, measured in a direction crossing a length direction of the address electrode 28, is smaller than the width W2 of a straight-line part 28a.

In addition, as shown in FIG. 4, a thickness D2 of the curved part 28b, which is measured in a third direction, the z direction, substantially perpendicular to the rear substrate 2, is thicker than a thickness D1 of the straight-line part 28a. For this reason, an increased resistance of the curved part 28b, occurring due to the reduced address electrode 28 width, can be prevented. Therefore, in the second exemplary embodiment, the address electrodes 28 have substantially the same volume per unit length in the straight-line part 28a and the curved part 28b.

Hereinafter, a process of generating a discharge between the address electrodes 8 or address electrodes 28, the scan electrode 16 and the sustain electrode 18 arranged as above will be described.

FIG. 6A is a sustain waveform diagram for a PDP according to an exemplary embodiment of the present invention. FIG. 6B is a schematic diagram for illustrating the formation of a discharge within a discharge cell in a PDP according to an exemplary embodiment of the present invention. In FIG. 6A, Vx is a voltage applied to a sustain electrode, Vy is a voltage applied to a scan electrode, and Vz is a voltage applied to an address electrode. The waveform applied to the address electrode has a period T and amplitude A. In FIG. 6B, the black arrow indicates a direction in which a discharge advances, and a white arrow indicates a direction in which an electric field is formed by a voltage difference. Voltages shown in FIG. 6B may be voltage levels when a discharge begins. In a sustain discharge, a sustain voltage can be approximately 160V and an address assistant pulse voltage can be approximately 80V.

The sustain waveform shown in FIG. 6A has a voltage pulse applied to the address electrode in synchronization with a conventional sustain voltage pulse. According to a positive column discharge characteristic, since a distance between the sustain electrode and the scan electrode is great, an initial discharge (i: trigger discharge) begins between the address electrode and the scan electrode or between the address electrode and the sustain electrode by a negative sustain voltage applied between the sustain electrode and the scan electrode. The initial discharge then diffuses along the address electrode (ii: diffusion discharge). A main discharge is finally generated between a sustain electrode and a scan electrode having a long discharge gap (iii: main discharge).

Discharge will be described in detail with reference to FIG. 6B. A discharge begins between the scan electrode and the address electrode by means of an electric field induced by Vxy and Vyz (i: trigger discharge). The discharge diffuses along the address electrode by electrons supplied to the first dielectric layer and the phosphor layer (ii: diffusion discharge). The discharge then diffuses to the sustain electrode, and a main discharge (iii: main discharge) is generated between a sustain electrode and a scan electrode within a discharge cell.

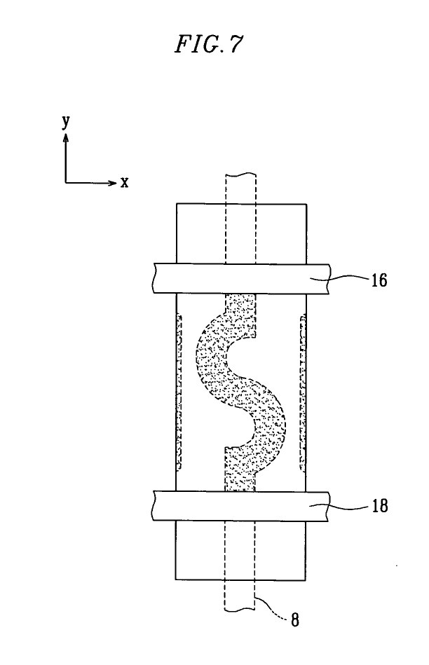

FIG. 7 is a schematic diagram for illustrating the distribution of visible ray radiation within a discharge cell, which is monitored when a PDP according to an exemplary embodiment of the present invention is driven. From FIG. 7, it can be seen that upon main discharge, strong visible rays radiate from around the barrier ribs 12, a surface portion in which the scan electrode 16 and the sustain electrode 18 are opposite to each other, and a portion corresponding to the address electrode 8 within a discharge cell, thus representing a region of high brightness.

As described above, in the PDP according to an exemplary embodiment of the present invention, panel efficiency can be enhanced by employing a positive column discharge characteristic. Furthermore, a high brightness portion can be expanded within a discharge cell to is emit a greater intensity of visible rays from a curved part of an address electrode. This can lead to improved brightness and luminous efficiency. In addition, by reducing the width of a curved part within a discharge cell, an increase in panel efficiency can be achieved without increasing an address current.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel (PDP), comprising:
a first substrate and a second substrate disposed opposite to each other;
a barrier rib disposed between the first substrate and the second substrate and partitioning a plurality of discharge cells;
an address electrode disposed on the first substrate and extending in a first direction; and
a first display electrode and a second display electrode disposed on the second substrate and extending substantially parallel to each other in a second direction substantially perpendicular to the first direction, the first display electrode and the second display electrode crossing with the address electrode at a region corresponding to a discharge cell,
wherein a distance between the first display electrode and the second display electrode is greater than a distance between the first display electrode and the address electrode, and a portion of the address electrode corresponding to the discharge cell has a path longer than a length of the discharge cell measured in the first direction.

2. The PDP of claim 1, wherein the address electrode comprises a straight-line part extending in the first direction and a curved part, and at least some of the curved part corresponds to the discharge cell.

3. The PDP of claim 2, wherein the curved part has an S shape.

4. The PDP of claim 2, wherein the curved part is curved at least twice in a portion of the address electrode corresponding to the discharge cell.

5. The PDP of claim 2, wherein the curved part comprises a path along two edges extending in the second direction of the discharge cell, and a path along two edges extending in the first direction of the discharge cell.

6. The PDP of claim 5, wherein the curved part has paths extending in opposite directions at two edges along the second direction of the discharge cell.

7. The PDP of claim 5, wherein the curved part is symmetrical about the center of the discharge cell.

8. The PDP of claim 2, wherein a length of the curved part is greater than a length of the straight-line part at a portion of the address electrode corresponding to the discharge cell.

9. The PDP of claim 2, wherein a width of the curved part, measured in a direction crossing a length direction of the address electrode, is smaller than a width of the straight-line part.

10. The PDP of claim 9, wherein a thickness of the curved part, measured in a third direction substantially perpendicular to the first substrate, is greater than a thickness of the straight-line part.

11. A plasma display panel (PDP), comprising:
a first substrate and a second substrate disposed opposite to each other;
a barrier rib disposed between the first substrate and the second substrate and partitioning a plurality of discharge cells;
an address electrode disposed on the first substrate and extending in a first direction, a portion of the address electrode corresponding to the discharge cell has a path longer than a length of the discharge cell measured in the first direction; and
a first display electrode and a second display electrode disposed on the second substrate and extending substantially parallel to each other in a second direction substantially perpendicular to the first direction,
wherein the first display electrode and the second display electrode correspond to a discharge cell and are formed of an opaque material.

12. The PDP of claim 11, wherein a distance between the first display electrode and the second display electrode is greater than a distance between the first display electrode and the address electrode.

13. The PDP of claim 11, wherein the address electrode comprises a straight-line part extending in the first direction and a curved part, and at least some of the curved part corresponds to the discharge cell.

14. The PDP of claim 13, wherein the curved part has an S shape curved at least twice at a portion of the address electrode corresponding to the discharge cell.

15. The PDP of claim 13, wherein the curved part comprises a path along two edges extending in the second direction of the discharge cell, and a path along two edges extending in the first direction of the discharge cell.

16. The PDP of claim 15, wherein the S shape has paths extending in opposite directions at two edges along the second direction of the discharge cell.

17. The PDP of claim 13, wherein a width of the curved part, measured in a direction crossing a length direction of the address electrode, is smaller than a width of the straight-line part.

18. The PDP of claim 17, wherein a thickness of the curved part, measured in a third direction substantially perpendicular to the first substrate, is greater than a thickness of the straight-line part.

19. A plasma display panel (PDP), comprising:
a first substrate and a second substrate disposed opposite to each other;
a barrier rib disposed between the first substrate and the second substrate and partitioning a plurality of discharge cells;
an address electrode disposed on the first substrate and extending in a first direction; and
a first display electrode and a second display electrode disposed on the second substrate and extending substantially parallel to each other in a second direction substantially perpendicular to the first direction, the first display electrode and the second display electrode crossing with the address electrode at a region corresponding to a discharge cell,
wherein the address electrode comprises a straight-line part extending in the first direction and a curved part, and at least a portion of the curved part corresponds to the discharge cell.

20. The PDP of claim 19, wherein a width of the curved part is smaller than a width of the straight-line part, and a thickness of the curved part, measured in a third direction substantially perpendicular to the first substrate, is greater than a thickness of the straight-line part.
